(19) United States
(12) Patent Application Publication
(10) Pub. No.: US 2007/0165343 A1
(43) Pub. Date: Jul. 19, 2007

(54) Circuit Arrangement and Method to Reduce Leakage Power and to Increase the Performance of a Circuit

(76) Inventors: Harry Barowski, Boeblingen (DE); Sebastian Ehrenreich, Schoenau (DE); Tobias Gemmeke, Boeblingen (DE); Jens Leenstra, Bondorf (DE)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(21) Appl. No.: 11/553,037

(22) Filed: Oct. 26, 2006

(30) Foreign Application Priority Data
Nov. 7, 2005 (EP) 05110400-5

(51) Int. Cl. H02H 9/08

(52) U.S. Cl. 361/43

(57) ABSTRACT

A Circuit arrangement to reduce leakage power and to increase the performance of a circuit comprising three electric potentials is described, wherein a diode is arranged between the third and the second or first electric potential to obtain a potential drop of the third electric potential and parallel to said diode a switch is arranged between the third and the second or between the third and the first electric potential to change the potential drop of the third electric potential opposite to the first or the second electric potential about the voltage drop of said diode wherein said switch comprises a transistor having a broad transistor channel. Furthermore a method to reduce leakage power and to increase the performance of a circuit by using said circuit arrangement is described.

### BACKGROUND OF THE INVENTION

The invention relates to a circuit arrangement to reduce leakage power and to increase the performance of a circuit comprising a first electric potential, a second electric potential and a third electric potential lying between the first and the second electric potential, wherein said third electric potential has a changeable potential drop opposite to the first or the second electric potential and wherein a circuit to be provided with a changeable supply voltage is arranged between said third and said second or first electric potential.

Modern technologies in chip design, e.g. like in processor or computer circuit design, suffer a high leakage current in the order of the dynamic power dissipation.

To reduce power dissipation within processors and/or computer devices it is known to cut-off certain circuits actually not being used from a clock signal triggering said circuits (clock gating). Examples for circuits exposed to clock gating are circuits being part of a sequential network within a processor.

Furthermore it is known to cut-off certain circuits from supply voltage (power gating). For power gating it is known to use header and/or footer devices to cut-off a particularly circuit from supply voltage and/or from ground. Thereby a header device is arranged between an upper electric potential and the circuit, wherein a footer device is arranged between a lower electric potential, e.g. ground and the circuit. Beside others the application of header and/or footer devices reduces leakage dramatically because they cut-off particular circuits from their supply nodes. Whereas leakage is almost eliminated the internal state of the particular circuits is lost. One disadvantage of this solution is a significant dead time when reactivating said circuit since the internal state the circuit had before it has been cut-off from supply voltage first has to be recovered when reactivating said circuit. Furthermore, the sudden change in current leads to large peaks in the supply network. Such a solution is only useable for circuits having a relatively low frequency in being cut-off and reconnected again.

The main contributors to leakage current are gate and subthreshold leakage, both being a strong function of supply voltage. As it can be seen in FIG. 4 showing a diagram describing the relative reduction of leakage power as a function of supply voltage Vdd respective lowering the supply voltage Vdd by ΔVdd, a reduction of Vdd between ΔVdd=0.2V and ΔVdd=0.4 V reduces leakage by a factor of two to five. Using this knowledge, it is also known to use an additional power source providing a supply voltage that can be varied locally to certain circuits (virtual ground). Doing so, there are three modes thinkable the circuit can be exposed to: power mode, wherein the circuit is exposed to full supply voltage: doze mode, wherein the circuit is exposed to a lower supply voltage and the internal state is retained; and sleep mode wherein the circuit is cut-off from supply voltage and the internal state is lost.

Thereby the most power efficient way to reduce supply voltage would be off chip. However, to allow a finer grain of voltage islands an on-chip approach is preferred.

In FIG. 3 known circuit arrangements according to such an on-chip approach are shown.

In FIG. 3a) a footer device 99 is shown using a control signal cntl to switch between doze mode and power mode. Thereby two circuit paths 100 are arranged parallel between an electric potential representing ground 110 and an electric potential to be used as virtual ground 111 for a circuit to be provided with a varying supply voltage. Three transistors 120 are required, one 121 arranged in a first circuit path 101 and two 122 and 123 serially arranged in a second circuit path 102. The control signal cntl either switches the transistor 121 arranged in the first circuit path 101 or switches the transistor 123 in the second circuit path 102.

By switching the first transistor an electric potential on virtual ground 111 is received compared with ground having a potential drop 110 equal to the voltage drop within the transistor 121 when switched. If the control signal cntl does not switch the transistor 121, it switches the transistor 123 in circuit path 102. Thereby a current flowing through the transistors 122 and 123 causes a potential drop between ground 110 and virtual ground 111 equal to the sum of the voltage drop within the transistors 121 and 122 when switched. The circuit arrangement in FIG. 3a) cannot switch to sleep mode. The potential drop between power and doze mode is relatively high so this arrangement can only be used in combination with circuits requiring a relatively high voltage during power mode because to retain the internal state of the circuit the relation of the voltage during doze mode and the voltage during power mode must keep a certain level. The relatively high potential drop also results in relatively high voltage peaks when switching between power and sleep mode and high energy dissipation being proportional to the square of the switched voltage. So the circuit arrangement shown in FIG. 3a) cannot be used in combination with modern processor architectures running with a relatively low supply voltage during power mode and requiring a relatively low potential drop between power and doze mode to retain the internal state of a circuit supplied by such an circuit arrangement. Another disadvantage of the circuit arrangement shown in FIG. 3a) is that the control signal cntl causes relatively high power dissipation in the circuit arrangement itself since it has to switch two transistors. So often changing between power and doze mode will destroy the power savings in the circuit supplied by the circuit arrangement because of the power dissipation of the control signal cntl in the circuit arrangement itself.

In FIG. 3b) a header device 98 is shown using three independent control signals sel0, sel1, sel2 to switch between sleep mode, doze mode and power mode. Thereby three parallel circuit paths 100 are arranged between an electric potential representing the supply voltage Vdd and an electric potential to be used as virtual supply voltage vitualVdd for a circuit to be provided with a varying supply voltage. Six transistors 120 are required, one 124 arranged in a first circuit path 103, two 125 and 126 serially arranged in a second circuit path 104 and three 127, 128 and 129 arranged in a third circuit path 105. Each control signal sel0, sel1, sel2 independently switches one of the transistors 124, 126 and 129 arranged in the circuit paths 103, 104 and 105.

This way it is possible to expose a circuit being supplied with the virtual supply voltage vitualVdd to power mode, two different deep doze modes and to sleep mode when none of the transistors is switched. A drawback of the circuit arrangement shown in FIG. 3b) is that it can only be used in combination with circuits requiring relatively high supply voltage since the potential drop between the different modes that can be switched are reducing the virtual potential too much, so that internal states of registers are lost and no preservation of states is possible. Another drawback of the circuit arrangement shown in FIG. 3b) is that power dissipation due to switching between the different modes is also relatively high since three control signals sel0, sel1, sel2 are required to switch between the modes, each switch causing power dissipation.

The disadvantage of the circuit arrangements according to the state of the art is that plenty of relatively large transistors are required to switch between the different modes. This leads to high power dissipation of the control signals used for switching these transistors. Hence the break-even number of cycles at reduced virtual supply voltage is too large for frequents state transitions. Furthermore the circuit arrangements cannot be used in combination with modern processor architecture based on relatively low supply voltage since the potential drops between power, doze and if available sleep mode are reducing the virtual potential too much, so that internal states of registers are lost and no preservation of states is possible.

### SUMMARY OF THE INVENTION

It is therefore an object of the invention to provide an improved circuit arrangement with reduced power dissipation and increased performance plus a method to increase the performance of and to reduce the power dissipation within a circuit being part of such a circuit arrangement.

The first object of the invention is achieved by a circuit arrangement to reduce leakage power and to increase the performance of a circuit comprising a first electric potential, a second electric potential and a third electric potential lying between the first and the second electric potential, wherein said third electric potential has a changeable potential drop opposite to the first or opposite to the second electric potential and wherein a circuit to be provided with a changeable supply voltage is arranged between said third and said second or between said third and said first electric potential, wherein a diode is arranged between said third and said second or first electric potential to obtain said potential drop of the third electric potential. A switch is arranged parallel to said diode between the third and the second or between the third and the first electric potential to change the potential drop of the third electric potential opposite to the first or the second electric potential about the voltage drop of said diode. Said switch comprises a transistor having a broad transistor channel. Such a transistor has a low voltage drop, so that the voltage drop between the third and the second or between the third and the first electric potential—depending on with which electric potential the third electric potential is connected via the diode and the switch—is low when bridging the diode by the switch.

If the diode is not bridged by the switch the voltage drop of the supply voltage caused by the potential drop of the third potential is large enough to reduce leakage power within said circuit significantly, and small enough to keep the internal state of said circuit during doze mode. Furthermore the potential drop caused by the diode can be adapted to relatively low supply voltages since it only depends on the material combination of the diode or any other device with equivalent electrical behaviour.

By using only one switch arranged in parallel to the diode, power dissipation due to switching that switch is minimized because only one switch has to be switched.

A transistor having a broad transistor channel has a negligible voltage drop also when high currents are flowing through that transistor. Using such a transistor in combination with a circuit arrangement to be used to switch between different supply voltages with high potential differences was not possible up to now because such a transistor has a high gate capacity. The high potential differences of the supply voltages to be switched in-between results in high power dissipation when switching such a transistor. Furthermore the circuit arrangements according to the state of the art required many transistors to be switched. In combination with the relatively high potential drops between the different supply voltages according to the state of the art a transistor having a broad transistor channel causes high power dissipation when switching between the different modes. Using a diode or any other device with equivalent electrical behaviour to achieve the potential drop between power and doze mode allows to used the circuit arrangement according to the invention in combination with circuits requiring relatively low supply voltages wherein also the potential drop between power and sleep mode is lower than according to the state of the art. This again allows using a transistor having a broad transistor channel to switch between power and doze mode because power dissipation due to changing gate voltage of such a transistor is reduced due to the lower potential drop. Furthermore, according to the invention only one transistor is necessary to switch between power and doze mode resulting in low power dissipation when switching between the different modes. Furthermore in a circuit arrangement according to the invention the relation between the potential drop that can be achieved during doze mode and the supply voltage during power mode is higher compared with the state of the art due to the lower supply voltage it can be used in combination with, resulting in higher relative power savings during doze mode.

Said circuit arrangement has the advantage over the state of the art, that it is simpler and uses fewer parts than circuit arrangements according to the state of the art. Therefore the power dissipation of the circuit arrangement according to the invention is reduced. Particularly the break-even number of cycles at reduced virtual supply voltage is small so it can be used for frequent state transitions, too. Furthermore it can be used in combination with circuits requiring relatively low supply voltages, because it is possible to influence the potential drop between power and doze by the material combination of the diode or any other device with equivalent electrical behavior. Using such a circuit arrangement in combination with low supply voltages has the further advantage of low voltage peaks when switching between power and doze mode.

Thereby it is thinkable that the diode is realized as a transistor that—compared with the transistor used to switch the diode—has a narrow transistor channel, resulting in a significant, desired voltage drop if the diode is not bridged.

In a preferred embodiment of said invention, depending on the desired voltage drop the material combination of the diode is selected. Thereby it is thinkable to use GaAs, SiAl or other known material combinations for the diode, depending on the voltage drop desired or required.

In a preferred embodiment of said invention, the circuit to be provided with the supply voltage uses CMOS (complementary metal oxide semiconductor) technology.

In another preferred embodiment of said invention the circuit to be provided with a changeable supply voltage is arranged between said third and a fourth electric potential, wherein said third electric potential has a changeable potential drop opposite to the first or the second electric potential and said fourth electric potential has a changeable potential drop opposite to the second or the first electric potential, similar to the potential drop of the third electric potential. Thereby the circuit is arranged between both, a header and a footer device, both having an independently changeable potential drop opposite to supply voltage Vdd and ground.

The second object of the invention is achieved by a method to reduce leakage power and to increase the performance of a circuit by using the circuit arrangement according to one of the claims 1 to 5, wherein said circuit can be switched to a doze mode instead or additional to a sleep mode, wherein the supply voltage of said circuit is reduced during doze mode in order to reduce leakage power within said circuit and to keep an internal state of the circuit during doze mode simultaneously, wherein said supply voltage is reduced by using a diode causing a voltage drop to a supply current flowing through said diode, said voltage drop being large enough to reduce leakage power within said circuit significantly, and small enough to keep the internal state of said circuit during doze mode, wherein said diode is switched by a switch being arranged parallel to said diode.

### BRIEF DESCRIPTION OF THE DRAWINGS

The present invention and its advantages are now described in conjunction with the accompanying drawings.

FIG. 1: Is a scheme of a footer circuit arrangement according to the invention;

FIG. 2: Is showing schemes of alternative embodiments of header and footer circuit arrangements according to the invention;

FIG. 3: Is showing schemes of header and footer circuit arrangements according to the state of the art; and

FIG. 4: Is a diagram describing the relative reduction of leakage power as a function of supply voltage.

### DETAILED DESCRIPTION

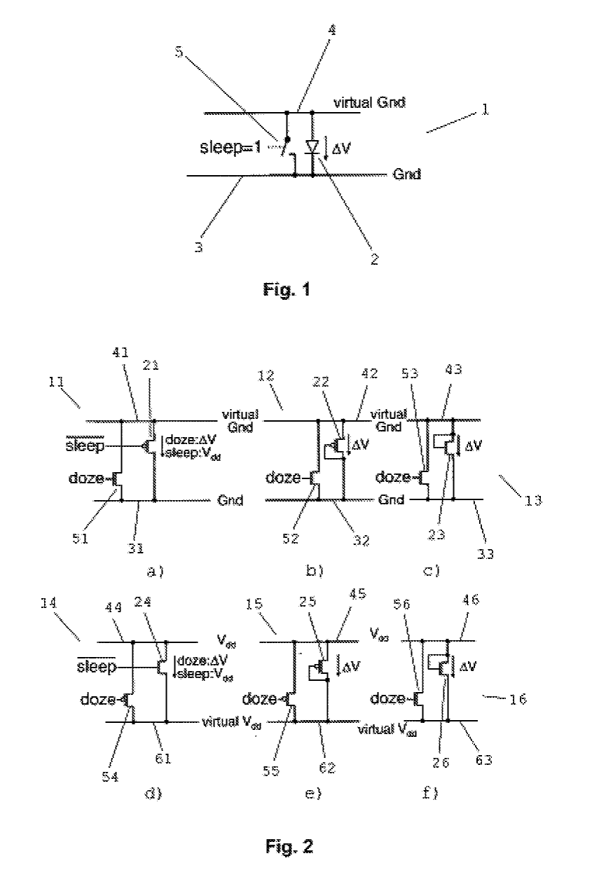

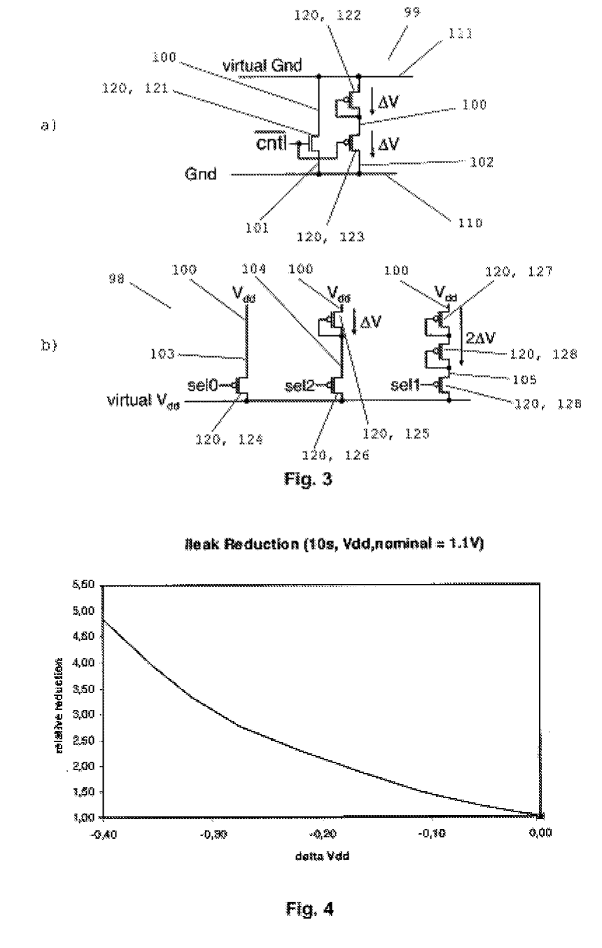

In FIG. 1 a footer circuit arrangement 1 is shown comprising a diode 2 that is arranged between a first electric potential 3 representing ground Gnd and a third electric potential 4 to be used as virtual ground. A switch 5 is arranged parallel to the diode 2 between the first 3 and the third 4 electric potential. A circuit not shown in FIG. 1 is arranged between the third electric potential 4 and a second electric potential also not shown in FIG. 1 with a defined potential difference to the first electric potential. By arranging the circuit between the third 4 and the second electric potential, the circuit can be provided with a changeable supply voltage. If the switch 5 is open, the diode 2 causes a potential drop between the first 3 and third potential 4. This potential drop reduces the supply voltage the circuit is provided with. If the switch 5 is closed, the diode 2 is bridged and the third potential is nearly equal to the first electric potential 3. In this case the supply voltage is nearly equal to the potential difference between the first 3 and the second electric potential not shown in FIG. 1.

Thereby the high supply voltage is used to energize the circuit arranged between the third 4 and the second potential during power mode. The lower supply voltage is used to energize the circuit during doze mode. The lower supply voltage is low enough to reduce leakage power significantly within said circuit during doze mode, and it is high enough to keep an internal state of the circuit during doze mode simultaneously.

Other embodiments of circuit arrangements 11, 12, 13, 14, 15, 16 according to the invention are shown in FIG. 2.

Thereby in the circuit arrangement 11 in FIG. 2a) the diode 2 in FIG. 1 is replaced by a transistor 21 that can be switched by a sleep signal and the switch 5 is replaced by a transistor 51 that can be switched by a doze signal. Thereby the transistor 51 performs a low voltage drop that is preferably equal to the voltage drop of the switch 5 in FIG. 1, wherein the transistor 21 has a voltage drop preferably equal to the diode 2 in FIG. 1. If the doze signal is high, a current exposed to a low voltage drop can flow through the transistor 51 and the third electric potential 41 is nearly equal to the first electric potential 31. If the doze signal is low, a current cannot flow through the transistor 51. In this case the third electric potential 41 can be cut-off completely from the first electric potential 31, wherein the potential drop relative to the second electric potential not shown in FIG. 2a) is equal to the supply voltage Vdd, or it can be connected with the first electric potential via the transistor 21, wherein the potential drop between the first 31 and the third electric potential 41 is equal to the voltage drop within the transistor 21. To cut-off the third electric potential 41 from the first electric potential 31 or to lower the third electric potential 41 opposite to the first electric potential 31 is controlled by a sleep signal is high and the doze signal is low, the third electric potential 41 is cut-off from the first electric potential 31. If the sleep signal is low and the doze signal is also low, the third electric potential 41 is lowered by the voltage drop of the transistor 21.

FIG. 2b) and 2c) show alternative embodiments of circuit arrangements 12, 13 similar to the embodiment shown in FIG. 1, wherein it is not possible to cut-off of the third electric potential 42, 43 from the first electric potential 32, 33, since the transistors 22, 23 cannot be switched by a control signal like the sleep signal in FIG. 2a). Thereby the third electric potential 42, 43 can be lowered by a doze signal switching the transistors 52, 53.

In the circuit arrangement 14 shown in FIG. 2d) the third electric potential to be used as virtual supply voltage is connected with a second electric potential 61 via a switch-able transistor 24 and a switch-able transistor 54 arranged parallel to the transistor 24. The circuit not shown in FIG. 2d) is arranged between in third electric potential 44 and the first electric potential not shown in FIG. 2d). The second electric potential 61 provides the supply voltage Vdd opposite to ground, i.e. the first electric potential not shown in FIG. 2d). The arrangement is similar to the arrangement in FIG. 2a), wherein the third electric potential is not connected with the first electric potential representing ground but with the second electric potential representing the supply voltage Vdd. The transistor 54 also performs a low voltage drop that is preferably equal to the voltage drop of the switch 5 in FIG. 1, wherein the transistor 24 has a voltage drop preferably equal to the diode 2 in FIG. 1. If the doze signal is high, a current exposed to a low voltage drop can flow through the transistor 54 and the third electric potential 44 is nearly equal to the second electric potential 61. If the doze signal is low, a current cannot flow through the transistor 54. In this case the third electric potential 44 can be cut-off completely from the second electric potential 61, wherein the potential drop relative to the first electric potential not shown in FIG. 2d) is equal to the supply voltage Vdd, or it can be connected with the second electric potential 61 via the transistor 24, wherein the potential drop between the second 61 and the third electric potential 44 is equal to the voltage drop within the transistor 24. To cut-off the third electric potential 44 from the second electric potential 61 or to lower the third electric potential 44 opposite to the second electric potential 61 is controlled by a sleep signal switching the transistor 24. If the sleep signal is high and the doze signal is low, the third electric potential 44 is cut-off from the second electric potential 61. If the sleep signal is low and the doze signal is also low, the third electric potential 44 is lowered by the voltage drop of the transistor 24.

FIG. 2e) and 2f) show alternative embodiments of circuit arrangements 15, 16 similar to the embodiment shown in FIG. 1, wherein the third electric potential 45, 46 is connected via the transistors 25, 26, 55, 56 with the second electric potential 62, 63 and not with the first electric potential. Thereby it is not possible to cut-off of the third electric potential 45, 46 from the second electric potential 62, 63, since the transistors 25, 26 cannot be switched by a control signal like the sleep signal in FIG. 2d). Thereby the third electrical potential 45, 46 can be lowered by a doze signal switching the transistors 55, 56.

In general it has to be mentioned that the wording of lowering or reducing the third potential describes a lowering or reduction of the supply voltage between the third and the other potential a circuit to be supplied with the supply voltage is arranged between.

Furthermore it is important to mention that the core idea of the invention is to use a diode to generate the supply voltage drop during doze mode. Thereby said diode can also be used to switch between power—and doze-mode, e.g. by using a switch being arranged parallel to the diode.

Generally it is also thinkable to combine the described power gating according to the invention with clock-gating wherein during doze mode certain circuits are cut-off from a clock signal triggering said circuits.

While the present invention has been described in detail, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

1. Circuit arrangement to reduce leakage power and to increase the performance of a circuit comprising a first electric potential, a second electric and a third electric potential lying between the first and the second electric potential, wherein said third electric potential has a changeable potential drop opposite to the first or the second electric potential and wherein a circuit to be provided with a changeable supply voltage is arranged between said third and said second or first electric potential, characterized in that a diode is arranged between said third and said second or between said third and said first electric potential to obtain said potential drop of the third electric potential wherein parallel to said diode a switch is arranged between the third and the second or between the third and the first electric potential to change the potential drop of the third electric potential opposite to the first or the second electric potential about the voltage drop of said diode wherein said switch comprises a transistor having a broad transistor channel.

2. Circuit arrangement according to claim 1, characterized in that depending on the desired voltage drop the material combination of the diode is selected.

3. Circuit arrangement according to claim 1, characterized in that the circuit uses CMOS technology.

4. Circuit arrangement according to claim 1, characterized in that the circuit to be provided with a changeable supply voltage is arranged between said third and a fourth electric potential, wherein said third electric potential has a changeable potential drop opposite to the first or the second electric potential and said fourth electric potential has a changeable potential drop opposite to the second or the first electric potential.

5. Method to reduce leakage power and to increase the performance of a circuit, wherein said circuit can be switched to a doze mode instead or additional to a sleep mode, wherein the supply voltage of said circuit is reduced during doze mode in order to reduce leakage power within said circuit and to keep an internal state of the circuit during doze mode simultaneously, wherein said supply voltage is reduced by using a diode causing a voltage drop to a supply current flowing through said diode, said voltage drop being large enough to reduce leakage power within said circuit significantly, and small enough to keep the internal state of said circuit during doze mode, wherein said diode is switched by a switch arranged parallel to said diode.
